(19) United States
(12) Patent Application Publication
(10) Pub. No.: US 2008/0142039 A1
(43) Pub. Date: Jun. 19, 2008

(54) REMOVAL OF NITRIDE DEPOSITS

(75) Inventors: Ing-Shin Chen, Danbury, CT (US); Jeffrey F. Roeder, Brookfield, CT (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 11/956,329

(22) Filed: Dec. 13, 2007

Related U.S. Application Data
(60) Provisional application No. 60/869,768, filed on Dec. 13, 2006.

(51) Int. Cl. C25F 1/00; C11D 7/26

(52) U.S. Cl. 134/1.2; 510/175; 134/107

(57) ABSTRACT

Compositions, apparatus and methods for removal of unwanted deposited materials, e.g., nitrides such as silicon nitrides, from substrates. In one implementation, such removal is carried out with a composition including (i) a halide, e.g., NF₃, ClF₃, F₂, XeF₂, CF₄, or other fluorocarbon species of the formula CₓF_{y}, wherein x and y have stoichiometrically compatible values, and (ii) a nitrogen source, optionally wherein at least the halide cleaning agent in the cleaning composition has been subjected to plasma generation to form a plasma. The use of relatively inexpensive nitrogen sources enables the amount of costly halide to be reduced in applications such as cleaning of internal surfaces and components of microelectronic product manufacturing process tool chambers.

### CROSS-REFERENCE TO RELATED APPLICATIONS

This application claims the benefit under 35 U.S.C. §119 of U.S. Provisional Patent Application No. 60/869,768 filed Dec. 13, 2006 in the name of Ing-Shin Chen, et al. The disclosure of the foregoing application is hereby incorporated herein in its entirety, for all purposes.

### FIELD OF THE INVENTION

The present invention relates to compositions, apparatus and methods for removal of deposited materials, e.g., nitrides such as silicon nitrides. In a specific implementation, the invention relates to cleaning of chambers of chemical processing equipment to remove nitride deposits therefrom.

### DESCRIPTION OF THE RELATED ART

In the manufacture of microelectronic devices, a variety of process tools are employed, having chambers that require cleaning to remove deposited materials from wall surfaces and internal structures of such chambers. Process tools, as such term is used herein, refers to apparatus that is utilized to conduct unit operations in microelectronic device manufacture, such as chemical vapor deposition, physical vapor deposition, etching, ion implantation, etc.

Various nitrides, including silicon nitride, titanium nitride, and tantalum nitride, are used in semiconductor processing as interlayer dielectrics and diffusion barriers. Post-processing deposit removal from the process tool is critical to ensure that deposits do not disengage, e.g., flake away, and contaminate the surface of a wafer during subsequent active processing, since such contamination can render the resulting microelectronic device product deficient or even useless for its intended purpose. Further, the chamber may include specialized components, such as collimators, shields, electrostatic chucks, etc., whose utility can be compromised by such deposits.

Accordingly, a variety of cleaning reagents and cleaning processes have evolved to address the need for removing unwanted deposits from microelectronic manufacturing tools and substrates on which such deposits are present.

In such cleaning operations, silicon nitride deposits are known to be particularly difficult to remove, in relation to other deposits such as silicon or silicon oxides. As a result, the conventional approach to cleaning process chambers containing silicon nitride deposits has been to extend the clean time of the chamber, to thereby increase the effectiveness of the cleaning operation.

This approach, however, consumes expensive source gases, and typically does not achieve complete removal. As a result of such incomplete cleaning, system performance is compromised. For example, vapor deposition process tools may use showerhead vapor feed devices in the process chamber, and incomplete cleaning of the chamber and its internal components means that the expensive showerhead must be replaced regularly because nitride deposits are not removed and eventually accumulate to a point that the showerhead openings become plugged, rendering the showerhead useless for delivery of deposition reagents.

It would therefore be a significant advance in the art to provide cleaning compositions and systems that enable removal of problematic nitrides such as silicon nitride from process chamber structures and other substrates on which such nitrides are present, in an effective, economic and readily implemented manner.

### SUMMARY OF THE INVENTION

The present invention relates to compositions, apparatus and methods for removal of nitride material, e.g., silicon nitrides.

The invention in one aspect relates to a composition comprising (i) a halide, and (ii) a nitrogen source, wherein at least the halide has been subjected to plasma generation to form a plasma. Such composition has utility for removal of nitrides such as silicon nitride on substrates on which the nitride is deposited.

As used herein, the term “halide” means a compound, complex or other chemical species containing a halogen constituent, viz., one or more of chlorine, fluorine, bromine or iodine.

As used herein, the term “nitrogen source” means a compound or complex containing nitrogen, e.g., a compound or complex that contains nitrogen radicals or is ionizable to form nitrogen radicals, such as by passage through a plasma generator or by exposure to an existing plasma.

The invention in another aspect relates to a method of removing nitride deposited on a substrate, said method comprising contacting the substrate with a cleaning composition selected from the group consisting of:

(i) compositions comprising (i) a halide, and (ii) a nitrogen source, optionally wherein at least the halide has been subjected to plasma generation to form a plasma;
(ii) compositions including NO and NO₂;
(iii) compositions including at least one fluorocompound selected from nitryl fluoride, nitrosyl fluorides and fluorine nitrate, optionally wherein the fluorocompound has been subjected to plasma generation to form a plasma;
(iv) compositions containing N₂F₄;
(v) compositions containing N₂O₄;
(vi) compositions including a halide selected from among NF₃, ClF₃ and CF₄;
(vii) nitrogen radicals and ionized halide;
(viii) compositions including NF₃ and a nitrogen source;
(ix) compositions including a halide selected from the group consisting of NF₃, ClF₃, F₂, XeF₂, CF₄, CₓF_{y}, NCl₃, N₂F₄, C₂F₆, C₄F₈, CFₓCl_{y}, COxF_{y}, Cl₂ and BCl₃, wherein x and y are stoichiometrically compatible, and a nitrogen source; and
(x) plasma compositions of the foregoing.

The invention in another aspect relates to a process for cleaning a substrate to remove nitride deposits therefrom, said process comprising vaporizing liquid N₂O₄ to generate a cleaning composition comprising NO and NO₂, and contacting said deposits with said cleaning composition.

In one aspect, the invention relates to a process for cleaning a substrate to remove nitride deposits therefrom, such process including contacting the nitride deposits with a cleaning composition including at least one fluorocompound selected from nitryl fluoride, nitrosyl fluorides and fluorine nitrate, wherein the fluorocompound optionally has been subjected to plasma generation to form a plasma.

In another aspect, the invention relates to a cleaning system, comprising:

a halide cleaning agent source, including a halide cleaning agent;
a plasma generator coupled with the halide cleaning agent source and adapted to receive halide therefrom and generate halide plasma;
flow circuitry connectable to the plasma generator, and adapted to dispense the halide plasma; and a nitrogen source supply package, adapted for flow of a nitrogen source to combine with at least one of the halide and halide plasma, and form a cleaning composition.

In another aspect, the invention relates to a method of cleaning a process chamber having silicon nitride deposits on surfaces therein, to remove said silicon nitride deposits, said method comprising contacting the silicon nitride deposits with a cleaning composition selected from the group consisting of:

(i) compositions comprising (i) a halide, and (ii) a nitrogen source, optionally wherein at least the halide has been subjected to plasma generation to form a plasma;
(ii) compositions including NO and NO₂;
(iii) compositions including at least one fluorocompound selected from nitryl fluoride, nitrosyl fluorides and fluorine nitrate, optionally wherein the fluorocompound has been subjected to plasma generation to form a plasma;
(iv) compositions containing N₂F₄;
(v) compositions containing N₂O₄;
(vi) compositions including a halide selected from among NF₃, ClF₃ and CF₄;
(vii) nitrogen radicals and ionized halide;
(viii) compositions including NF₃ and a nitrogen source;
(ix) compositions including a halide selected from the group consisting of NF₃, ClF₃, F₂, XeF₂, CF₄, CₓF_{y, NCl}₃, N₂F₄, C₂F₆, C₄F₈, CFₓCl_{y}, COxF_{y}, C1₂ and BCl₃, wherein x and y are stoichiometrically compatible, and a nitrogen source; and
(x) plasma compositions of the foregoing.

Other aspects, features and embodiments of the invention will be more fully apparent from the ensuing disclosure and appended claims.

### BRIEF DESCRIPTION OF THE DRAWINGS

FIG. 1 is a schematic representation of a cleaning system according to one embodiment of the present invention.

FIG. 2 is a schematic representation of a cleaning system according to another embodiment of the invention.

FIG. 3 is a schematic representation of a cleaning system according to still another embodiment of the invention, including nitrogen, fluorine and oxygen sources.

FIG. 4 is a schematic representation of a cleaning system according to yet another embodiment of the invention, utilizing N₂O₄ as a cleaning source material.

FIG. 5 is a schematic representation of a cleaning system according to a further embodiment of the invention, using a ClF₃ cleaning source material, and optional nitrogen source, for cleaning of a process chamber, and monitoring of the effluent from the process chamber during the cleaning process by an endpoint monitoring unit.

FIGS. 6-8 show various views of an endpoint monitor that may be utilized for monitoring of the cleaning process in a system of the type shown schematically in FIG. 5.

FIG. 9 shows a view of another endpoint monitor that may be utilized for monitoring of effluent from a cleaning operation in a system of the type shown schematically in FIG. 5.

### DETAILED DESCRIPTION OF THE INVENTION, AND PREFERRED EMBODIMENTS THEREOF

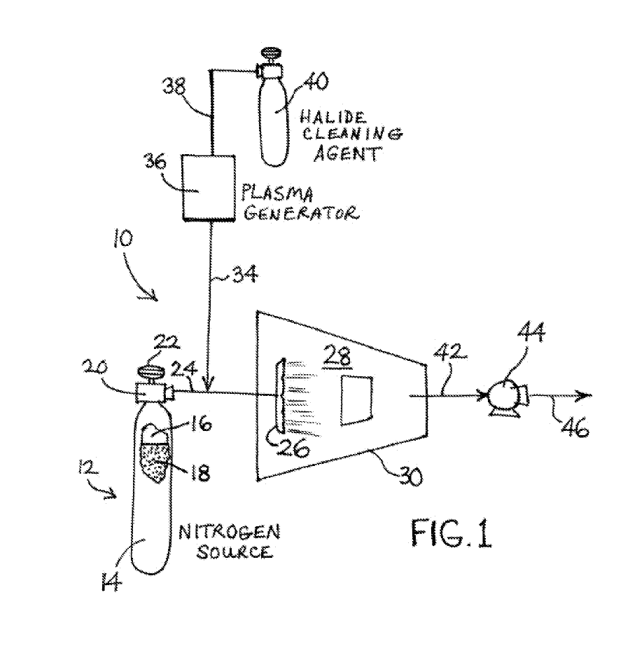

Referring now to the drawings, FIG. 1 is a schematic representation of a cleaning system 10 according to one embodiment of the present invention, in which a plasma-based cleaning composition is used to remove unwanted silicon nitride deposits from wall surfaces and internal structures of a chamber in a microelectronic device manufacturing process tool.

The cleaning system 10 includes a cleaning reagent storage and dispensing package 12, containing a nitrogen source. This package includes a container 14 defining an interior volume 16 optionally containing a storage medium 18, which may include a solid or liquid material in which a nitrogen source, e.g., nitric oxide (NO), is stored. The storage medium may for example include a physical adsorbent on which nitric oxide or other nitrogen source is adsorbed, and from which it is desorbed under dispensing conditions. In some instances, the container 14 may be an empty vessel that is filled with the nitrogen source, without any storage medium therein.

The container 14 in the FIG. 1 embodiment includes a valve head assembly 20 having a valve element therein. The valve head assembly is actuatable by a manually operable handwheel 22, or by an automatic valve actuator that is coupled with process control instrumentation and monitoring equipment (not shown) arranged to cause the valve in the valve head assembly to selectively open or close.

The valve head assembly 20 has a valve passage in its interior (not shown), containing a valve element that is translatable between a fully closed and a fully opened position. The valve element is coupled with the handwheel 22 or other actuator for such purpose.

In a dispensing operation, the valve in the valve head assembly is opened, and the nitrogen source, e.g., nitric oxide (NO) gas, is flowed from the nitrogen source container into the discharge line 24. The flow of nitrogen source into the discharge line can be effectuated by a pressure differential between the interior volume of container 14 and the downstream flow circuitry, such as by pumping action of the pump 44 downstream of the process chamber 30, and/or by input of heat to the container to desorb the nitric oxide from the storage medium, and/or by other dispensing conditions causing egress of nitric oxide from the container. The nitrogen source may be stored in the source container at elevated pressure, but it generally is desirable to utilize a low pressure, e.g., sub-atmospheric pressure, storage condition, for reasons of safety.

The cleaning system 10 further includes a primary cleaning reagent package 40, which may be constituted by a container holding the primary cleaning reagent. The primary cleaning reagent advantageously comprises a halide, such as nitrogen trifluoride (NF₃).

The primary cleaning reagent package 40 is coupled by line 38 with the plasma generator 36. The plasma generator is arranged to generate plasma from the primary cleaning reagent flowed to the generator from package 40. The plasma generator in turn is coupled with the feed line 34 to accommodate flow of plasma from the generator to the discharge line 24 containing nitrogen source flowing to the chamber 30 of a microelectronic device manufacturing process tool.

The discharge line 24 by such arrangement of feed line 34 receives the halide (NF₃) plasma discharged from the plasma generator 36, so that the nitrogen source (nitric oxide) in discharge line 24 mixes and interacts with the halide plasma from feed line 34 to form nitrogen radicals in the plasma. The thus-formed nitrogen radicals augment the cleaning action of the resulting stream of cleaning composition that is flowed to chamber 30 in discharge line 24.

The discharge line 24 is coupled with shower head dispenser 26 in the interior volume 28 of the chemical vapor deposition chamber 30, to convey the cleaning composition into the interior of the chamber 30 for cleaning of the walls and showerhead therein.

The chemical vapor deposition chamber 30 is joined by vacuum line 42 to vacuum pump 44. In one embodiment of the system illustrated in FIG. 1, nitric oxide is stored in and dispensed from the storage and dispensing container 14 at subatmospheric pressure, with the vacuum pump 44 providing the requisite pressure drop for extraction of the nitric oxide from the container 14 for mixing in line 24 with the NF₃ plasma and flow of the resulting cleaning composition through the deposition chamber 30 for cleaning thereof. The vacuum pump exhausts the interior volume 28 of the chemical vapor deposition chamber, and discharges the pumped fluid in line 46 as effluent from the cleaning process. Such effluent may be passed to an effluent abatement unit (not shown) for treatment.

It will be appreciated that the nitrogen source discharge line 24, halide line 38 and/or plasma line 34 may be suitably valved and/or manifolded for flow and mixing of the nitrogen source and the halide plasma.

The cleaning system illustratively described in connection with FIG. 1 enables the cleaning efficacy of a halide primary cleaning agent, e.g., nitrogen trifluoride (NF₃), as supplied from primary cleaning reagent package 40, to be significantly enhanced by the addition of a nitrogen source, e.g., nitric oxide (NO), to produce a cleaning composition.

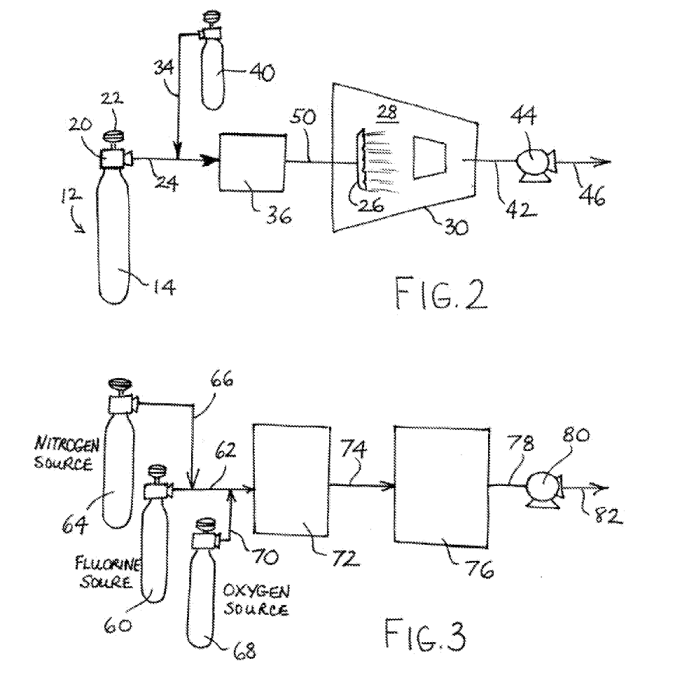

FIG. 2 is a schematic representation of a cleaning system according to another embodiment of the invention.

In the FIG. 2 system, the nitrogen source from cleaning reagent storage and dispensing package 12 is flowed in discharge line 24 and is mixed with halide (NF₃) added from line 34, which dispenses the halide from the halide supply package 40. The nitrogen source package 12 includes a container 14 equipped with a valve head 20 and handwheel 22 (or alternatively, an automatic valve actuator). The resulting NF₃/NO mixture then flows in line 24 to the plasma generator 36 to form a plasma containing nitrogen radicals deriving from the nitrogen source, and halide radicals deriving from the halide (NF₃) supplied by halide supply package 40. Such plasma constitutes the cleaning composition, and flows from the plasma generator in line 50 to the chemical vapor deposition chamber 30.

In the chemical vapor deposition chamber 30, line 50 is coupled with shower head dispenser 26 in the interior volume 28 of the chemical vapor deposition chamber 30, to convey the cleaning composition into the interior of the chamber 30 for cleaning of the walls and showerhead therein.

The chemical vapor deposition chamber 30 is joined by vacuum line 42 to vacuum pump 44. The vacuum pump exhausts the interior volume 28 of the chemical vapor deposition chamber, and discharges the cleaning effluent from the process system in line 46. Such effluent may be passed to an effluent abatement unit (not shown) for treatment.

It will be recognized that the cleaning system may be configured as a combination of the reagent supply and plasma generation schemes of FIGS. 1 and 2, in which nitrogen source is added to the halide material to form a mixture that then is subjected to plasma generation, and in which additional nitrogen source is added to such plasma downstream of the plasma generator.

As a still further alternative, the cleaning system may be arranged with suitable valving and/or manifolding of the supply lines, so that the system can be operated in either, as well as both, of such “upstream” nitrogen source addition or “downstream” nitrogen source addition modes, the terms “upstream” and “downstream” referring to the nitrogen source addition to the halide as occurring before or after the plasma generation to which the halide reagent is subjected, respectively.

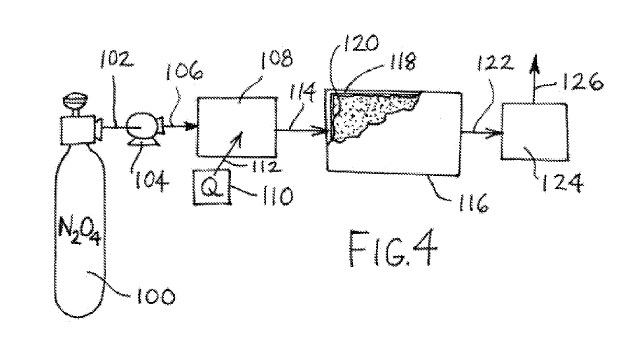

FIG. 3 is a schematic representation of a cleaning system according to still another embodiment of the invention, including nitrogen, fluorine and oxygen sources.

As illustrated, the nitrogen source storage and dispensing package 64 is coupled with a first dispensing line 66 for dispensing a nitrogen source compound or complex into a second dispensing line 62 coupled to a fluorine source storage and dispensing package 60. An oxygen source storage and dispensing package 68 is coupled with a third dispensing line 70. The first and third dispensing lines 66 and 68, respectively, are coupled with second dispensing line 62, e.g., by appropriate fittings or connectors, so that a nitrogen source material from package 64 and an oxygen source material from package 68 are introduced to and mixed with the fluorine source material in second dispensing line 62.

By this arrangement, the nitrogen source, fluorine source and oxygen source are mixed with one another to form a feed stream that is flowed into the plasma generator 72 to form a plasma comprising corresponding nitrogen, fluorine and oxygen plasma species. Such plasma then is flowed from the plasma generator 72 in line 74 to the process chamber 76 to be cleaned, whereby deposits on the interior wall services and components in the process chamber 76 are at least partially removed by the nitrogen/fluorine/oxygen plasma.

The plasma cleaning effluent is discharged from the process chamber 76 in line 78, under the action of discharge pump 80, and flows in outlet line 82 to an abatement system or other disposition.

The nitrogen source in such cleaning system may include nitrogen (N₂), ammonia, or other reagent containing nitrogen. The oxygen source may include one or more of oxygen, ozone, carbon monoxide, carbon dioxide, water and hydrogen peroxide. The fluorine source may include one or more of xenon difluoride, chlorine trifluoride, fluorine (F₂), fluorocarbons, etc.

As a variation of the process scheme illustratively described in connection with FIG. 3, the cleaning system may utilize reagents that provide two of the nitrogen, fluorine and oxygen components, or even all three of such components, as the source for generating a cleaning plasma. For example, the oxygen source may also be a nitrogen source, as in the case of use of NO, N₂O and/or NO₂ as reagent(s) in the cleaning system that are subjected to plasma exposure. The fluorine source may also be a nitrogen source, as in the use of NF₃ or other fluoronitrogen compound that is used as plasma generation feedstock. The reagent further may provide all of the nitrogen, fluorine and oxygen components, in the case of a nitrogen oxyfluoride compound being used as a cleaning reagent that is subjected to plasma exposure to form the cleaning plasma. It will therefore be recognized that the schematic process system shown in FIG. 3 may be simplified by the provision of two or even one source supply vessels, when the reagents used provide multiple ones of the nitrogen, fluorine and oxygen components that are submitted to plasma generation to form the cleaning plasma.

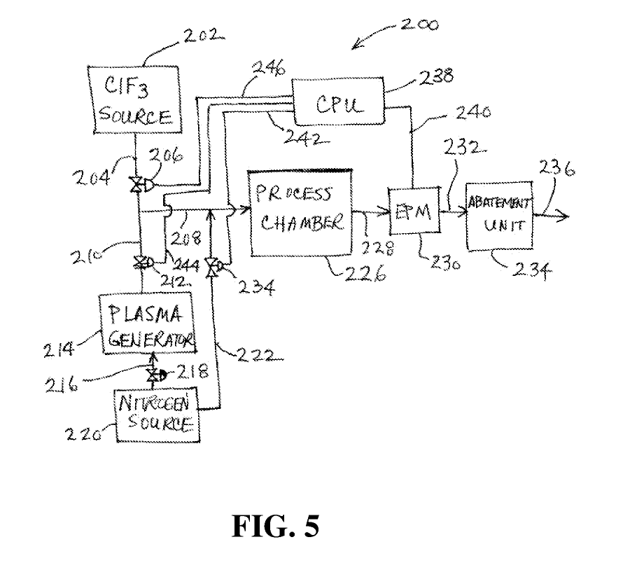

FIG. 4 is a schematic representation of a cleaning system according to yet another embodiment of the invention, utilizing N₂O₄ as a cleaning source material. In some applications, it may also be feasible to utilize N₂O₂ as a cleaning source material, which is highly reactive. N₂O₂ may be less preferred as a cleaning reagent in some applications, and it may be efficacious in specific implementations to use N₂O₂ in combinations with an inert carrier medium or other stabilizing agent that enables the high reactivity of such reagent to be used in an effective manner.

The cleaning system shown in FIG. 4 utilizes a source of liquid N₂O₄ such as the storage and dispensing vessel 100 illustratively depicted. The source vessel 100 is coupled with a dispensing line 102 joined in turn to pump 104, which serves to withdraw the N₂O₄ reagent from vessel 100 and to discharge same in line 106 to the vaporizer 108. The vaporizer what weight comprises a chamber that is heated by heater 110, which serves to introduce to the vaporizer chamber a heat flux Q whose input to the vaporizer chamber is schematically represented by the arrow 112.

The heater 110 may be of any suitable type, such as a heating jacket for the vaporizer chamber, radiant or electrical resistance heater, or other suitable device or assembly providing the requisite heat input. The level and rate of heating may be controlled by a suitable control system that involves monitoring of the pump speed or flow rate of the N₂O₄ in line 106, and correspondingly modulates the heating effected by the heater 110, to produce a corresponding N₂O₄ vapor.

The N₂O₄ vapor is flowed from the vaporizer 108 in line 114 to the process chamber 116. The process chamber 116 is shown in partial breakaway view, as comprising a chamber wall 118 having deposited material 120 thereon. The N₂O₄ vapor introduced in line 114 contacts the deposited material 120 to effect at least partial removal thereof from the surfaces of the chamber wall 118.

The resulting N₂O₄ vapor containing removed material then is discharged from the process chamber 116 in line 122 and flows to abatement complex 124, in which the effluent may be treated, e.g., for recovery of N₂O₄ or for scrubbing, chemical reaction, incineration or other final treatment and disposition. A purified effluent may be generated and discharged from the abatement complex 124 in discharge line 126.

The foregoing embodiments of FIGS. are of an illustrative character, to show various process schemes and apparatus arrangements that may be usefully employed in various embodiments of the invention.

In general, the present invention contemplates a variety of compositions, apparatus and methods for removing unwanted material, e.g., nitride contaminants such as silicon nitrides, from substrates. The cleaning compositions of the invention may be utilized for cleaning of chambers of microelectronic manufacturing process tools, to remove silicon nitrides and other deposited contaminants therefrom.

The cleaning compositions of the invention are usefully employed to remove nitride deposits from a substrate having such deposited nitride thereon, by contact of the cleaning compositions with the deposited nitride for sufficient time to at least partially remove the deposited nitride from the substrate. The cleaning compositions are typically administered to the substrate by gas phase or plasma phase contacting of the substrate with the cleaning composition, but may be applied in any other suitable manner, as may be necessary or desirable in a given implementation of the invention.

Cleaning compositions of the invention for removing nitrides such as silicon nitride from a substrate having same deposited thereon, can include any of the following:

(i) compositions comprising (i) a halide, and
(ii) a nitrogen source, wherein at least the halide has been subjected to plasma generation to form a plasma;
(ii) compositions including NO and NO₂;
(iii) compositions including at least one fluorocompound, e.g., nitryl fluoride, nitrosyl fluorides and fluorine nitrate, wherein the fluorocompound optionally has been subjected to plasma generation to form a plasma;
(iv) compositions containing N₂F₄; and
(v) compositions including a halide cleaning agent selected from among NF₃, ClF₃ and CF₄.

The invention in one specific embodiment provides a cleaning system and method wherein nitrogen trifluoride or other halide is employed as a cleaning reagent and subjected to plasma generation in a plasma generator, and the plasma is enhanced in cleaning effect by the addition of a nitrogen radical booster agent. The nitrogen radical booster agent can be a reagent that is concurrently subjected to plasma generation with the NF₃ reagent, and/or it may be combined with the NF₃ plasma downstream of the plasma generator, whereby nitrogen radical formation is enhanced.

In various embodiments, the cleaning composition includes (i) a primary cleaning agent and (ii) a nitrogen source, in which at least the primary cleaning agent has been subjected to plasma generation to form a plasma.

The cleaning compositions of the invention are used to remove unwanted deposits, e.g., of nitrides such as silicon nitrides, from a substrate contaminated with such deposit, by contacting the cleaning composition with the substrate for sufficient time to effect at least partial removal of the deposit.

The substrate to be cleaned can be of any suitable type, e.g., a surface, a structure, article, body, matter or material, having the unwanted deposit associated therewith, and susceptible to removal of the deposit in contact with the cleaning composition.

In a specific embodiment, the invention relates to a cleaning system including (i) a halide source, e.g., NF₃, in a supply and dispensing vessel or other supply package, (ii) a nitrogen source, such as nitric oxide in another supply and dispensing vessel or supply package, and associated flow circuitry by which (a) at least the halide source supply package can be coupled with a plasma generator, and (b) the nitrogen source material from the nitrogen source supply package can be mixed with halide deriving from the halide source supply package, upstream and/or downstream of such plasma generator.

The flow circuitry for such purpose can include piping, conduits, manifolds, etc. with associated instrumentation and devices therein, such as valves, mass flow controllers, restrictive flow orifices, pressure transducers, pressure regulators, pumps, compressors, thermocouples or other temperature monitoring devices, composition or concentration monitors, monitors, scrubbers, purifiers, etc.

The cleaning system in another embodiment can include a halide source supply package, nitrogen source supply package, flow circuitry, and a plasma generator operatively coupled with the flow circuitry to receive halide source material from the halide source supply package, and optionally to additionally receive nitrogen source material from the nitrogen source supply package, in which the flow circuitry is adapted to deliver the cleaning composition, comprising plasma including halide and nitrogen radicals.

Thus, the flow circuitry can be arranged so that the nitrogen source material is mixed with the halide source material, to form a mixture for flow to the plasma generator, and/or the flow circuitry can be arranged so that the nitrogen source material supplied by the nitrogen source supply package is mixed with halide plasma discharged from the plasma generator.

Thus, the invention in various embodiments provides a process for cleaning a substrate to remove nitride deposits therefrom, in which the nitride deposits are contacted with a cleaning composition including (i) a halide primary cleaning agent and (ii) a nitrogen source, in which at least the halide primary cleaning agent has been subjected to plasma generation.

Although the invention is variously described herein in reference to NF₃ as a primary cleaning agent, the invention also contemplates the use of numerous other primary cleaning agents. In general, any cleaning agent may be employed that is effective in a plasma form for cleaning to effect removal of deposits, and that is enhanced in cleaning action by the presence of nitrogen radicals.

For thermal cleaning processes in which elevated temperature conditions are employed in the cleaning operation, additive gases can optionally be added to the primary cleaning agent downstream from the plasma generator. In thermal processes at high temperatures, halides can be used as primary cleaning reagents that are optionally combined with additive gases that thermally dissociate to form nitrogen sources in situ.

For example, the cleaning composition may comprise NF₃, NCl₃, or ClF₃/N₂O as the primary cleaning agent, with corresponding nitrogen-radical sources for the cleaning composition including NFₓ, NClₓ (x<3) and nitrogen oxides, respectively.

For cleaning of process tool chambers involving thermal processes at low temperatures (at which thermal decomposition does not occur), direct injection of nitrogen source material into the process chamber can be employed. NO and NO₂ are nitrogen sources that can be used in such approach.

While ammonia (NH₃) can be used as a nitrogen source in various embodiments of the invention, the presence of hydrogen in such compound reduces the available oxidizing etchants (e.g., halogens) available to the cleaning process. It is preferable that companion ions in the cleaning composition are oxidizers themselves (e.g., oxygen or halogens). Accordingly, nitrogen sources employed in some embodiments of cleaning compositions of the invention may advantageously exclude ammonia.

In other embodiments, the present invention contemplates the formation of nitric oxide as a cleaning species, using N₂O₄ as a (liquid) source with a vaporizer to generate the active NO species, in which the vapor is predominantly NO₂, e.g., in a process arrangement as illustratively shown and described with reference to FIG. 4 hereof. At 1 atmosphere pressure, NO₂ starts to decompose into NO and O₂ at 150° C. The remaining NO₂ also promotes nitride removal but to a lesser extent. The decomposition is complete at 600° C.

The reaction of N₂O₄ to form NO as a cleaning species proceeds according to the following reaction:

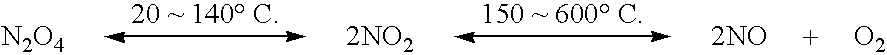

In general, this reaction can be carried out in a process for cleaning a chamber, e.g., of a microelectronic device manufacturing process tool, by metered delivery of N₂O₄ liquid into a heated vaporization zone to generate the NO and NO₂ species in situ for subsequent flow of the cleaning species to the chamber to be cleaned. N₂O₄ as a liquid is much denser than pressurized NO gas, and therefore N₂O₄ can be provided from a storage and delivery package that is much smaller than a corresponding pressurized gas package containing NO gas.

N₂O₄ may also be used as a cleaning source material in combination with an oxygen-containing species, as well as with F-N-O species such as nitryl and nitrosyl fluorides (e.g., FNO, FNO₂), and fluorine nitrate (F₃NO).

The invention further contemplates the use of N₂F₄ as a cleaning agent that does not require plasma excitation to react with silicon deposits.

It will be appreciated that the cleaning method of the invention may variously utilize any of the above-described cleaning agent species, as components of cleaning compositions, e.g., for cleaning of deposits from substrates containing same, such as silicon nitride deposits from wall surfaces and components in chambers of microelectronic device manufacturing process tools.

Preferred halide species in cleaning compositions of the invention include halides selected from among NF₃, ClF₃, F₂, XeF₂, CF₄, and other fluorocarbon species of the formula CₓF_{y}, wherein x and y have stoichiometrically compatible numerical values.

Preferred nitrogen sources include nitric oxide (NO) and/or nitrogen dioxide (NO₂), optionally further combined with oxygen (O₂) and/or ozone (O₃). Oxygen may be combined with a nitrogen-containing species prior to injection into a plasma, so that NO_{y} species—nitrogen sources—are generated. In place of oxygen, ozone (O₃) or nitrous oxide (N₂O) can be employed. In general, the nitrogen source can include any suitable compounds, complexes or species, e.g., to provide nitrogen radicals that enhance the cleaning efficacy of primary cleaning agents such as nitrogen trifluoride or other halide cleaning agents.

The nitrogen source in various embodiments serves as a booster agent that is injected into a NF₃ plasma upstream of the substrate to be cleaned, e.g., a chamber of a microelectronic device manufacturing process tool. The NF₃ plasma reacts with the nitrogen source booster agent to generate cleaning species that are effective for the cleaning operation. These gaseous booster agents are inexpensive as compared to NF₃ and permit the amount of NF₃ to be reduced while at the same time achieving reasonable etch rates on the nitride deposits, so that the overall cleaning operation is improved in cost-efficiency.

Nitrogen sources in the broad practice of the present invention can include reagents that are utilized as single component agents to effect cleaning removal of nitride deposits by nitrogen radical formation in situ in contact with the deposits, or nitrogen sources that are utilized as feedstock for plasma generation, or nitrogen sources that are utilized to assist and improve the cleaning action of other nitride deposit removal agents.

The nitrogen source in various preferred embodiments is NO, wherein such nitrogen source is subjected to plasma generation along with a halide cleaning agent, e.g., NF₃.

In various other embodiments, the nitrogen source is combined with a NF₃ plasma, with the interaction between the NF₃ plasma and the nitrogen source producing nitrogen radicals for enhanced cleaning, in relation to a corresponding cleaning composition lacking such nitrogen source. The cleaning composition is contacted with the deposits to be removed. Such contacting may include batch, semi-batch or alternatively continuous flow contacting of the cleaning composition with the deposits, and is carried out for sufficient time to at least partially remove the deposits.

Cleaning compositions of the invention are particularly advantageous for cleaning microelectronic device manufacturing process tool chambers. The chambers to be cleaned may be of any suitable type, e.g., chemical vapor deposition chambers, containing nitride deposits such as deposits of silicon nitride. The chambers in various specific embodiments are utilized in a microelectronic device manufacturing facility adapted for the manufacture of semiconductor products and/or flat-panel displays.

Although compositions of the invention are variously described herein as used for cleaning substrates such as chamber walls to remove nitrides such as silicon nitride therefrom, it will be realized that such compositions also have utility as etching agents for silicon nitride in the manufacture of microelectronic device products, such as integrated circuits and flat panel displays. The invention therefore contemplates a process for etching nitride material, e.g., nitride material deposited on a substrate, by contacting the nitride material with a composition selected from among:

(i) compositions comprising (i) a halide, and (ii) a nitrogen source, wherein at least the halide has been subjected to plasma generation to form a plasma;
(ii) compositions including NO and NO₂;
(iii) compositions including at least fluorocompound selected from nitryl fluoride, nitrosyl fluorides and fluorine nitrate, wherein the fluorocompound optionally has been subjected to plasma generation to form a plasma;
(iv) compositions containing N₂F₄; and
(v) compositions including a halide cleaning agent selected from among NF₃, ClF₃ and CF₄.

In cleaning processes of the invention, the processes generally can be carried out at any suitable pressure, but preferably are conducted at near-atmospheric or at subatmospheric pressures.

In various embodiments, the nitrogen source material may be stored in and dispensed from a package including a container that holds a storage medium for the nitrogen source. Such storage media may be of any suitable types.

In one embodiment, the storage medium includes a solid physical adsorbent, e.g., carbon, porous silicon, silica, alumina, etc., on which the nitrogen source is sorptively retained during storage and from which the nitrogen source is desorbed under dispensing conditions. In another embodiment, the storage medium includes an ionic liquid, in which the nitrogen source is stored and from which the nitrogen source is released under dispensing conditions.

The nitrogen source supply package can be configured in any suitable manner for specific applications. For example, the package can include a container holding the nitrogen source, and the container may be provided with an interiorly or exteriorly disposed check valve and/or flow restrictor, or the package may for example include a container having an interiorly disposed pressure-actuated flow control assembly. The pressure-actuated flow control assembly can by way of further example include a fixed set point regulator, or alternatively a variable set point regulator, or a combination regulators of both types, in series.

The nitrogen source supply package can be adapted to dispense the nitrogen source at any suitable pressure, e.g., a subatmospheric pressure, such as a pressure below about 700 torr. The nitrogen source supply package can be fabricated in many alternative forms, as may be useful or desirable in specific embodiments of the invention.

In various specific applications, the halide cleaning agent in the cleaning composition includes a compound selected from among ClF₃ and CF₄, which has been subjected to plasma generation, and the cleaning composition also includes a nitrogen source such as nitrogen gas (N₂), and optionally further includes oxygen gas (O₂). The nitrogen gas and the oxygen gas can be added to the plasma, and/or to the halide cleaning agent prior to plasma generation.

The halide cleaning agent in another embodiment includes a nitrogen halide selected from one of NF₃ and NCl₃.

In yet another specific embodiment of the invention, the halide cleaning agent in the cleaning process includes ClF₃ and the nitrogen source includes NO₂.

The cleaning systems of the invention can be configured for operation in a wide variety of specific arrangements, and the cleaning processes of the invention can be carried out using any appropriate apparatus, as readily determinable within the skill of the art, based on the disclosure herein.

The cleaning system in one preferred arrangement is constructed and arranged so that the nitrogen source supply package dispenses the nitrogen source to combine with the halide cleaning agent upstream and/or downstream of the plasma generator, as described in connection with FIGS. 1 and 2 hereof.

In one embodiment of the downstream arrangement, the halide cleaning agent, comprising NF₃, and a nitrogen source are combined after the NF₃ has been subjected to plasma generation to form a corresponding NF₃ plasma, to create an interaction between the NF₃ plasma and the nitrogen source producing nitrogen radicals. Such interaction between the NF₃ plasma and the nitrogen source can be carried out in the process tool that is being cleaned, i.e., in situ in such tool.

In the cleaning of surfaces and internal structure of a process tool chamber in accordance with the present invention, the cleaning composition is suitably flowed through the process tool chamber for sufficient time to achieve a predetermined extent of removal of deposits from the chamber. Preferably, nitrate deposits present in the chamber are removed in major part, and most preferably, such nitrate deposits are substantially completely removed from the chamber.

The process tool in such respect can be of any suitable type, and can for example comprise a vapor deposition chamber, etching chamber or other structure having unwanted nitride deposits thereon, e.g., deposits of silicon nitride and/or other metal nitride species. The process tool can be situated in a microelectronic device manufacturing facility, and a vacuum pump may be provided for coupling to the process tool, to maintain pressure therein at a suitable level, e.g., a sub-atmospheric pressure level, for the cleaning operation. Consistent therewith, the nitrogen source supply package may be adapted to dispense the nitrogen source at subatmospheric pressure.

In a specific arrangement, a cleaning system is arranged to include the following system components: an NF₃ source; a plasma source unit coupled with the NF₃ source and adapted to receive NF₃ therefrom and generate an NF₃ plasma; flow circuitry adapted to interconnect the plasma source unit with the process tool, and adapted to flow the NF₃ plasma from the plasma source unit; and a nitrogen source supply package adapted for flow of a nitrogen source to combine with at least one of the NF₃ and NF₃ plasma.

Another specific arrangement of the cleaning system includes the following system components: a source of liquid N₂O₄; a vaporizer coupled with the source of liquid N₂O₄ to receive liquid N₂O₄ therefrom, and to vaporize the liquid N₂O₄ to form a vapor including NO and NO₂; and flow circuitry coupled to the vaporizer and adapted for dispensing the vapor including NO and NO₂ for cleaning applications.

A further arrangement of the cleaning system includes the following system components: a cleaning composition source containing at least one fluorocompound selected from the group consisting of nitryl fluoride, nitrosyl fluorides and fluorine nitrate; a plasma generator; first flow circuitry interconnecting the cleaning composition source and the plasma generator, arranged to feed the at least one fluorocompound from the cleaning composition source to the plasma generator for generation of a cleaning composition plasma; and second flow circuitry coupled to the plasma generator and adapted to deliver the plasma cleaning composition, e.g., to a microelectronic device manufacturing process tool chamber.

In another specific embodiment, the cleaning system includes the following system components: a cleaning composition source containing N₂F₄; and flow circuitry coupled with the cleaning composition source and adapted to deliver cleaning composition, e.g., to a microelectronic device manufacturing process tool chamber.

The deployment of a nitrogen source booster agent and a halide plasma in accordance with the invention may be carried out in a simple and efficient manner using existing flow circuitry that is associated with a chamber to be cleaned in the microelectronic device manufacturing facility. Such existing flow circuitry typically includes a flow passage joining the process tool with a remote plasma source (RPS) unit. This flow passage in the vicinity of the process tool can be used in the normal operation of the tool and therefore may be coupled, e.g., by a manifold, header or other piping or conduit structure, with process gas feed lines that feed organometallic reagents, carrier gases, diluents, etc. to the process chamber in the normal processing mode of such process tool. In this circumstance, the existing flow circuitry of the tool can be readily adapted to introduce the nitrogen radical booster agent, NO₂, NO and/or O₂, or other agent, through existing feed lines, so that the booster agent is introduced to, and combined with, a halide plasma such as NF₃ plasma.

Accordingly, such use of the nitrogen source booster agent does not require RPS modification, since the tool user can simply connect a gas cylinder of NO, NO₂, O₂ or other gaseous booster agent to an existing gas manifold to implement booster agent injection into the plasma downstream of the RPS unit. Additionally, in the case of NO, NO₂, and O₂ as booster agents, many tools already have one or more of these gases plumbed into the process tool system (for introduction to the process chamber during normal “on-stream” process operation of the tool, during deposition on the substrate, or other wafer or microelectronic device processing steps), in which event no process tool modification is necessary, in implementing the use of the booster agent to enhance the cleaning operation.

The booster agent in various embodiments may advantageously be supplied in a sub-atmospheric package that provides a high degree of safety in the chamber clean operation utilizing such assistive reagent. For example, the booster agent, e.g., NO, can be packaged in a container provided with an interiorly or exteriorly disposed check valve and/or flow restrictor. In one preferred embodiment, the booster agent is provided in a gas package comprising an interiorly disposed pressure-actuated flow control assembly, which may include a fixed set point or a variable set point regulator. Gas packages of such type are commercially available from ATMI, Inc. (Danbury, Conn., USA) under the trademark VAC, and are more fully described in U.S. Pat. No. 6,089,027, U.S. Pat. No. 6,101,816 and U.S. Pat. No. 6,343,476.

Sorbent-based fluid storage and dispensing gas packages in which the gas is stored and dispensed at low pressures, e.g., subatmospheric pressure levels below about 700 torr, of a type as disclosed in U.S. Pat. N0. 5,518,528, may also be employed for storage and dispensing of the booster agent in the broad practice of the present invention. Gas packages of such type are commercially available from ATMI, Inc. (Danbury, Conn., USA) under the trademarks SDS and SAGE.

More generally, other sorbent-based booster agent storage and dispensing packages can be employed, in which the sorbent medium includes a solid, liquid, semi-solid, or other material having capability as a storage medium. For example, the booster agent storage medium may be a reversible reactive liquid medium, e.g., an ionic liquid medium, capable of reactive uptake of fluid in a first step, and reactive release of previously taken up fluid in a second step, wherein the first and second steps are reverse reactions in relation to one another, and define a reversible reaction scheme. Packages of such type are described, for example, in US Patent Publication No. 20040206241.

Additional packages that may be employed for delivery of booster agent include the packages described in U.S. Pat. No. 5,704,965; U.S. Pat. No. 5,704,967; U.S. Pat. No. 5,707,424; U.S. Patent Application Publication 20040206241; U.S. Pat. No. 6,921,062; U.S. Patent Application Publication 20050006799; and U.S. Patent Application Publication 20030111014.

In another embodiment, the booster agent or other cleaning reagents may be provided as a solid source material, in suitable packages such as the solid source material storage and vapor dispensing package commercially available from ATMI, Inc. (Danbury, Conn., USA) under the trademark ProE-Vap. Packages of such type are described in U.S. Pat. No. 6,921,062; International Patent Application Publication No. WO2006/101767; and U.S. Patent Publication No. 20050039794.

The booster agent container in the above-mentioned storage and delivery packages are desirably sized and any storage medium employed is desirably chosen so that sufficient flow and volume of booster agent is available to accommodate both safe handling and low cost of ownership, with only infrequent change-outs of the supply package being necessary.

Although the foregoing discussion relates to the packaging of the booster agent, similar types of packaging may be employed for storage and dispensing of the primary cleaning agent, e.g., halide cleaning agent.

The booster agent supply package, the primary cleaning agent supply package, and associated flow circuitry may be provided as an assembly for turn-key installation in a semiconductor manufacturing facility, flat panel display manufacturing facility or other microelectronic device manufacturing facility, in various embodiments of the invention. In other embodiments, the booster agent supply package, the primary cleaning agent supply package, the associated flow circuitry, the plasma generator may be provided as an assembly for turn-key installation in a facility of the above-mentioned types.

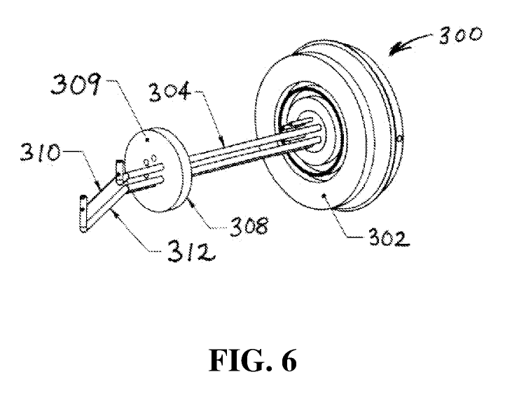

FIG. 5 is a schematic representation of a cleaning system according to a further embodiment of the invention, using a ClF₃ cleaning source material, and optional nitrogen source, for cleaning of a process chamber, and monitoring of the effluent from the process chamber during the cleaning process by an endpoint monitoring unit.

As shown in FIG. 5, system 200 includes a halide source 202 containing ClF₃ as the cleaning reagent. The ClF₃ source 202 is coupled with a dispensing line 204 having flow control valve 206 therein, with dispensing line 204 being coupled with feed line 208, for flow of cleaning gas to the process chamber 226 to be cleaned.

The process chamber has an effluent line 228 by which effluent gas is passed to the endpoint monitoring (EPM) unit 230, for monitoring of the cleaning operation, as hereinafter more fully described.

The cleaning effluent after passage through the EPM unit 230 is flowed in line 232 to abatement unit 234 for effluent treatment of the cleaning effluent, and discharge of a treated effluent stream in discharge line 236.

The system 200 also includes a nitrogen source 220 for supply of a nitrogen cleaning reagent to the process chamber. The nitrogen source is coupled with discharge line 216 containing flow-control valve 218 therein, for flowing nitrogen source to plasma generator 214. The plasma generator is equipped with a discharge line 210 containing flow-control valve 212 therein, for flowing plasma deriving from the nitrogen source cleaning agent to feed line 208, together with the cleaning reagent from ClF₃ source 202.

As an alternative feed modality, nitrogen source 220 is equipped with a discharge line 222 that bypasses plasma generator 214, and connects with feed line 208. Discharge line 222 contains flow-control valve 234 therein. By this arrangement, and related valving in the flow-circuitry of the system, ClF₃ cleaning reagent may be flowed into the process chamber alone, or it may be combined with nitrogen source cleaning agent and/or nitrogen source plasma, as may be desired in a specific application.

The endpoint monitor unit 230 contains a suitable endpoint monitor for monitoring the progress of the cleaning operation in process chamber 226. For example, the endpoint monitor may be arranged to sense specific deposit or contaminant species in the process chamber that are removed by the cleaning operation, so that when such components are no longer sensed in the effluent, the endpoint monitor is effective to output a signal indicative of such endpoint having been reached in the cleaning operation. For this purpose, the EPM unit 230 may be linked by a signal transmission line 240 to central processing unit (CPU) 238, as illustrated.

The CPU 238 may in turn be arranged with respective signal transmission lines 242, 244 and 246, for transmission of control signal to the valves 234, 212 and 206, respectively, for actuation and opening in such valves or any one or more of them, or for closing such valves, or otherwise modulating same to adjust the flow rate of specific reagent in the conduits passing associated therewith.

The abatement unit 234 may be arranged to include scrubbers, oxidizers, incineration equipment, or other apparatus for neutralizing or otherwise rendering innocuous the contaminants and hazardous components in the effluent stream.

The CPU 238 may include a microprocessor, programmable logic controller, microcontroller, general purpose programmable computer, or other computational unit constructed and arranged for processing of a signal from the endpoint unit and for controlling the valves 206, 212 and 234, to modulate the flow of cleaning reagents from the various sources of same.

In various implementations, the process chamber may be cleaned solely by ClF₃ alone, so that no nitrogen source or nitrogen plasma is involved. In other applications, it may be advantageous to utilize ClF₃ in combination with the nitrogen source in an un-ionized form. Alternatively, the ClF₃ may be employed with nitrogen source plasma, as a combined cleaning reagent, or plasma and non-plasma amounts of nitrogen source material may be utilized in combination with the halide, or otherwise alone or in sequence with administration of ClF₃ to the process chamber for cleaning thereof. It will be appreciated that the system shown in FIG. 5 is variably adaptable to carry out a variety of cleaning operations utilizing the halide and/or nitrogen source material. In lieu of ClF₃ other halogen cleaning agents could be used, including fluorocarbons such as CF₄, C₂F₆, and C₄F₈, or chlorofluorocarbons (of the formula CFₓCl_{y}), and compounds such as COₓF_{y}, wherein x and y in the foregoing formulae are stoichiometrically appropriate for compounds containing the specified atomic constituents.

In the broad practice of the present invention wherein a nitrogen source and halide combination is used for cleaning, the ratio of the nitrogen component to the halide component may be widely varied. In general, compositions containing at least 10% nitrogen, based on the total volume of nitrogen and halogen components up to 100% based on the total volume (i.e., in a 1:1 volumetric ratio of nitrogen component and halogen component) may be advantageously employed.

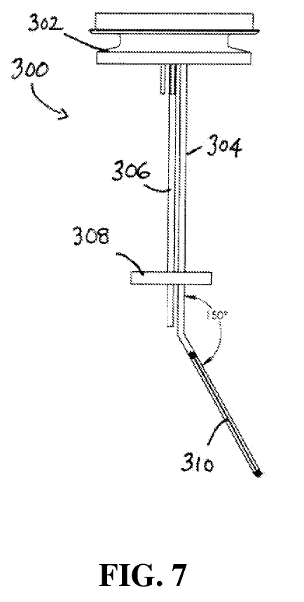

FIGS. 6-8 show various views of an endpoint monitor that may be utilized for monitoring of the cleaning process in a system of the type shown schematically in FIG. 5.

FIG. 6 is a perspective view of the endpoint monitor 300, as including a flange member 302 from which posts 304 and 312 extend. The posts extend through spreader 308, shown with distal surface 309 oriented view in the schematic illustration of FIG. 6.

The posts 304 and 312 are bent at their distal ends, as shown in elevation view in FIG. 7, presenting fixtures for securing a sensing filament 310 between them. FIG. 8 is a bottom plan view showing the orientation of the posts 304 and 312 and the filament therebetween, with the direction of gas flow shown by the reference arrow. The flange may include a series of nickel and stainless steel pins 314, as illustrated.

In exposure to halogen, the filament 310 of the sensor interacts and changes resistance. Such resistance change then is transmitted as a signal from the associated sensor assembly to the CPU in a system of the type shown in FIG. 5.

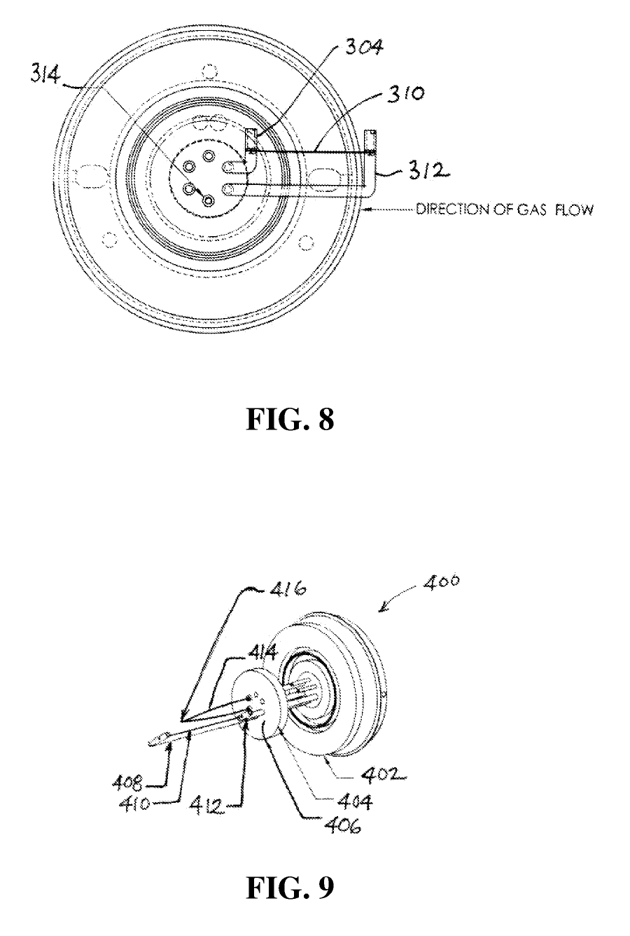

FIG. 9 shows a view of another endpoint monitor that may be utilized for monitoring of effluent from a cleaning operation in a system of the type shown schematically in FIG. 5.

As shown in FIG. 9 the sensor 400 includes a flange element 402, on which are mounted a series of posts, including posts 408 and 412, each featuring bent distal ends, from which is suspended a sensing filament 410. The posts 408 and 412 extend through the spreader 404, the distal face 406 of which is shown in the drawing of FIG. 9. Mounted on and extending from the spreader is a wishbone-shaped filament constituting a thermocouple assembly, of which the separate legs are joined at distal extremity 416, as shown.

In use, the sensing filament and wishbone assembly contact the effluent gas from the cleaning operation and the sensing filament 410 changes resistance as a result of interaction with halogen components in the cleaning effluent stream. The wishbone filament 414 changes electrical resistance properties and is effective for adjusting and compensating for different thermal conditions that may otherwise affect the sensing filament 410.

The endpoint sensor may be of the foregoing types illustratively shown in FIGS. 6-9, or alternatively may be constituted by other endpoint monitoring devices. Illustrative devices that may find application in the broad practice of the present invention, in systems of the type schematically shown in FIG. 5, for example, are more fully described in the following U.S. patents and published patent applications: U.S. Pat. No. 7,080,545, U.S. Pat. No. 7,296,458, U.S. Pat. N0. 7,228,724; U.S. Pat. N0. 7,296,460; U.S. Publication 2004/0163445; U.S. Publication 2005/0230258; U.S. Publication 2005/0205424; and U.S. Publication 2006/0211253.

While the invention has been described herein in reference to fluorine and fluoride species as exemplary halide cleaning agents, it will be recognized that non-fluorohalides are usefully employed in specific applications of the invention, and that chlorine, boron trichloride, etc. as well as other halogen species, may be usefully employed in the broad practice of the present invention.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A method of removing nitride deposited on a substrate, said method comprising contacting the substrate with a cleaning composition selected from the group consisting of:
(i) compositions comprising (i) a halide, and (ii) a nitrogen source, optionally wherein at least the halide has been subjected to plasma generation to form a plasma;
(ii) compositions including NO and NO₂;
(iii) compositions including at least one fluorocompound selected from nitryl fluoride, nitrosyl fluorides and fluorine nitrate, optionally wherein the fluorocompound has been subjected to plasma generation to form a plasma;
(iv) compositions containing N₂F₄;
(v) compositions containing N₂O₄;
(vi) compositions including a halide selected from among NF₃, ClF₃ and CF₄;
(vii) nitrogen radicals and ionized halide;
(viii) compositions including NF₃ and a nitrogen source;
(ix) compositions including a halide selected from the group consisting of NF₃, ClF₃, F₂, XeF₂, CF₄, CₓF_{y}, NCl₃, N₂F₄, C₂F₆, C₄F₈, CFₓCl_{y}, COxF_{y}, Cl₂ and BCl₃, wherein x and y are stoichiometrically compatible, and a nitrogen source; and
(x) plasma compositions of the foregoing.

2. The method of claim 1, wherein the cleaning composition includes a nitrogen source selected from the group consisting of NO, NO₂, N₂O, NH₃, N₂, and N₂O₄.

3. The method of claim 1, wherein the cleaning composition comprises ClF₃.

4. The method of claim 1, wherein the cleaning composition comprises NF₃ and a nitrogen source.

5. The method of claim 1, wherein the cleaning composition comprises at least one fluorocompound selected from nitryl fluoride, nitrosyl fluorides and fluorine nitrate.

6. The method of claim 1, wherein the cleaning composition comprises N₂F₄.

7. The method of claim 1, wherein the cleaning composition comprises CF₄.

8. The method of claim 1, wherein the cleaning composition comprises a halide selected from the group consisting of NF₃, ClF₃, F₂, XeF₂, CF₄, CₓF_{y}, NCl₃, N₂F₄, C₂F₆, C₄F₈, CFₓCl_{y}, COxF_{y}, Cl₂ and BCl₃, wherein x and y are stoichiometrically compatible, and a nitrogen source.

9. The method of claim 1, wherein the cleaning composition comprises a halide selected from the group consisting of CF₄, CₓF_{y}, NCl₃, C₂F₆, C₄F₈, CFₓCl_{y}, COxF_{y}, Cl₂ and BCl₃, wherein x and y are stoichiometrically compatible.

10. The method of claim 1, wherein the cleaning composition comprises N₂O₄.

11. The method of claim 1, wherein the cleaning composition comprises a halide or a halide plasma, a nitrogen source selected from among NO, NO₂ and N₂O, optionally further including O₂ and/or O₃.

12. The method of claim 1, wherein the cleaning composition comprises (i) a halide, and (ii) a nitrogen source, optionally wherein at least the halide has been subjected to plasma generation to form a plasma.

13. The method of claim 1, wherein the substrate comprises a surface of a chamber of a microelectronic device manufacturing tool.

14. The method of claim 1, wherein the nitride deposited on the substrate comprises at least one nitride selected from the group consisting of silicon nitride, titanium nitride and tantalum nitride.

15. The method of claim 1, further comprising monitoring effluent produced by said contacting to determine an end point of said contacting, and terminating said contacting in response to determination of said end point.

16. A process for cleaning a substrate to remove nitride deposits therefrom, said process comprising vaporizing liquid N₂O₄ to generate a cleaning composition comprising NO and NO₂, and contacting said deposits with said cleaning composition.

17. The process of claim 16, wherein the cleaning composition further comprises an oxygen-containing species.

18. A process for cleaning a substrate to remove nitride deposits therefrom, such process including contacting the nitride deposits with a cleaning composition including at least one fluorocompound selected from nitryl fluoride, nitrosyl fluorides and fluorine nitrate, wherein the fluorocompound optionally has been subjected to plasma generation to form a plasma.

19. The process of claim 18, wherein the fluorocompound has been subjected to plasma generation.

20. A cleaning system, comprising:
a halide cleaning agent source, including a halide cleaning agent;
a plasma generator coupled with the halide cleaning agent source and adapted to receive halide therefrom and generate halide plasma;
flow circuitry connectable to the plasma generator, and adapted to dispense the halide plasma;
a nitrogen source supply package, adapted for flow of a nitrogen source to combine with at least one of the halide and halide plasma, and form a cleaning composition.

21. The cleaning system of claim 20, as arranged to flow the cleaning composition to a microelectronic device manufacturing tool for cleaning thereof.

22. The cleaning system of claim 21, further comprising an end point monitor arranged to monitor the cleaning and produce an output indicative of an end point of said cleaning.

23. A method of cleaning a process chamber having silicon nitride deposits on surfaces therein, to remove said silicon nitride deposits, said method comprising contacting the silicon nitride deposits with a cleaning composition selected from the group consisting of:
(i) compositions comprising (i) a halide, and (ii) a nitrogen source, optionally wherein at least the halide has been subjected to plasma generation to form a plasma;
(ii) compositions including NO and NO₂;
(iii) compositions including at least one fluorocompound selected from nitryl fluoride, nitrosyl fluorides and fluorine nitrate, optionally wherein the fluorocompound has been subjected to plasma generation to form a plasma;
(iv) compositions containing N₂F₄;
(v) compositions containing N₂O₄;
(vi) compositions including a halide selected from among NF₃, ClF₃ and CF₄;
(vii) nitrogen radicals and ionized halide;
(viii) compositions including NF₃ and a nitrogen source;
(ix) compositions including a halide selected from the group consisting of NF₃, ClF₃, F₂, XeF₂, CF₄, CₓF_{y}, NCl₃, N₂F₄, C₂F₆, C₄F₈, CFₓCl_{y}, COxF_{y}, Cl₂ and BCl₃, wherein x and y are stoichiometrically compatible, and a nitrogen source; and
(x) plasma compositions of the foregoing.

24. The method of claim 23, wherein the cleaning composition comprises N₂O₄.

25. The method of claim 23, wherein the cleaning composition comprises ClF₃.
